(19) United States
(12) Patent Application Publication
(10) Pub. No.: US 2021/0374112 A1
(43) Pub. Date: Dec. 2, 2021

(54) MIGRATION SUPPORT SYSTEM, MIGRATION SUPPORT METHOD, AND NODE

(71) Applicant: Hitachi, Ltd., Tokyo (JP)

(72) Inventors: Takayuki NAGAI, Tokyo (JP); Yoji OZAWA, Tokyo (JP); Nao NISHIJIMA, Tokyo (JP)

(73) Assignee: Hitachi, Ltd.

(21) Appl. No.: 17/187,194

(22) Filed: Feb. 26, 2021

(30) Foreign Application Priority Data
May 28, 2020 (JP) 2020-093045

(51) Int. Cl. G06F 16/21; G06F 16/23

(52) U.S. Cl. CPC G06F 16/214; G06F 16/2379

(57) ABSTRACT

A migration support system 10 includes a node of a first distributed ledger system built on a blockchain platform 4500, wherein the node 2000 includes: a storage device that holds information on organizations that are allowed to participate in a distributed ledger system on each of blockchain platforms; and a computing device configured to, when the first distributed ledger system is migrated to another blockchain platform to build a second distributed ledger system, record, in a distributed ledger 2500 of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

### CROSS-REFERENCE TO RELATED APPLICATION

This application claims priority pursuant to 35 U.S.C. § 119 from Japanese Patent Application No. 2020-093045, filed on May 28, 2020, the entire disclosure of which is incorporated herein by reference.

### BACKGROUND

### Technical Field

The present invention relates to a migration support system, a migration support method, and a node.

### Related Art

A technology has emerged in which transactions that have traditionally been conducted through trusted central authorities such as financial institutions and governments are replaced with direct transactions by P2P (Peer to Peer) between users. That is, it is a distributed ledger technology using a blockchain (hereinafter, also referred to as BC).

In terms of this distributed ledger technology, various derivative technologies have been proposed and progressed. The main features of the current distributed ledger technology are as follows: (1) In a transaction between participants on a distributed ledger, the transaction is determined through consensus building and approval by (any or a specific) participant, not by the central authority, (2) Blocks, into which a plurality of transactions are grouped, are recorded in the distributed ledger in a daisy chain called a blockchain, and hash calculation is performed on consecutive blocks to make them virtually impossible to falsify, and (3) Sharing the same ledger data among all participants enables all the participants to confirm the transactions.

Such a distributed ledger technology using BC is suitable as a mechanism for managing/sharing reliable data and executing/managing transactions based on contracts because of the above features. Therefore, the distributed ledger technology is being studied for application in a wide range of fields such as finance and manufacturing.

By using an infrastructure for providing a distributed ledger (hereinafter, referred to as a distributed ledger infrastructure), information sharing and transactions can be performed among a plurality of entities without management by a central authority (e.g., multiple companies involved in consortiums and supply chains in a specific industry).

Note that a blockchain or distributed ledger in which only computers authorized by a plurality of specific parties/people or one specific party/person are participants in transactions is called a “consortium type”.

For the consortium blockchain or distributed ledger, there is a management entity that authenticates participants. Accordingly, the consortium blockchain or distributed ledger has the advantage of increased speed of transaction approval. Due to such an advantage, in a case where the distributed ledger technology is used within a consortium of a specific industry, a consortium distributed ledger infrastructure is generally used.

In some distributed ledger infrastructures, it is possible to manage not only transaction data but also logic that defines transaction conditions in the distributed ledger so that they can be applied to complicated transaction conditions and various applications. This logic is called a smart contract (hereinafter, also referred to as an SC).

For example, “Hyperledger Fabric” retrieved from <URL: http://hyperledger-fabric.readthedocs.io/en/latest/> (retrieved on 2020.02.01) discloses a technique relating to a distributed ledger infrastructure having an SC execution function. In this distributed ledger infrastructure, a transaction (hereinafter, also referred to as a TX) is received while a consensus is built between nodes that configure the distributed ledger infrastructure at a predetermined agreement level, the TX is executed in respective nodes, and then the result of the TX is held, so that information (ledger) is shared among a plurality of nodes. The distributed ledger infrastructure also has the SC execution function that executes predetermined logic for TXs.

Attempts have also been made to improve the efficiency of business processes by using a consortium BC for cross-organizational business. In this case, a ledger that stores the transaction history of all business operators participating in a BC will be shared among the business operators. This is not always preferable from the viewpoint of maintaining the confidentiality of each business operator. Thus, a possible case is that where a distributed ledger is shared only between organizations that have a predetermined business relationship.

In order to deal with such a case, “Hyperledger Fabric” referred to above suggests a concept referred to as “Channel” that divides a distributed ledger in a logical manner. The distributed ledger infrastructure in this case is one distributed ledger infrastructure in which all organizations participate while having an internal configuration in which the distributed ledger infrastructure is divided into a plurality of distributed ledger infrastructures in a logical manner.

Hereinafter, a set of nodes belonging to one of the distributed ledger infrastructures obtained by this logical division will be referred to as a “subgroup”. Each node belonging to the above-described subgroup shares the distributed ledger only with the nodes in the same subgroup. When a TX is executed, the node executes an SC installed for each subsystem and updates the data of the distributed ledger associated with the corresponding subgroup.

On the other hand, a plurality of cloud vendors that provide a consortium BC in the form of Platform as a Service (PaaS) are starting. Such a service is referred to as a blockchain (BC) platform.

After the operation of an application or service utilizing the BC platform starts, there may be a need to migrate to the BC platform of another vendor.

The reason may be that the service in use has ended, or the version or type of BC infrastructure required by the application or service no longer matches the BC platform side, or the like.

However, in a general BC platform, it is generally common that raw data of a distributed ledger and information such as a pair of a secret key and a public key used for authentication of participating organization and signatures on TXs are not permitted to be taken out of the platform.

As one method for solving such a problem, a technique has been proposed in which one virtual ledger is formed from a plurality of ledgers by linking a terminal block and a starting block (see U.S. Pat. No. 10, 417,188).

When a distributed ledger or the like on a BC platform is migrated to another BC platform based on the above-described conventional technique, if the distributed ledger on the migration source BC platform is deleted, then there is a problem that the past TX history cannot be referred to. In order to avoid such a problem, it is necessary to continuously maintain resources such as distributed ledgers on both the migration source and migration destination BC platforms. This causes a problem of increased costs for operating the BC platform.

In addition, there is a problem that the secret key used for authentication of participating organizations cannot be inherited between the migration source and migration destination BC platforms. In that case, one organization needs to use a plurality of pieces of organization definition information properly between the migration source and migration destination BC platforms. This leads to increased operating costs for that organization.

Therefore, an object of the present invention is to provide a technique for efficiently performing seamless migration of a distributed ledger or the like between BC platforms.

### SUMMARY

A migration support system of this disclosure to solve the above objective, comprises a node of a first distributed ledger system built on a blockchain platform, wherein the node includes a storage device that holds information on organizations that are allowed to participate in a distributed ledger system on each of blockchain platforms; and a computing device configured to, when the first distributed ledger system is migrated to another blockchain platform to build a second distributed ledger system, record, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

A migration support method of this disclosure performed by a node of a first distributed ledger system built on a blockchain platform comprises holding information on organizations that are allowed to participate in a distributed ledger system on each of blockchain platforms in a storage device; and recording, when the first distributed ledger system is migrated to another blockchain platform to build a second distributed ledger system, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

A node of this disclosure is a node of a first distributed ledger system built on a blockchain platform, comprising a storage device that holds information on organizations that are allowed to participate in a distributed ledger system on each of blockchain platforms; and a computing device configured to, when the first distributed ledger system is migrated to another blockchain platform to build a second distributed ledger system, record, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

According to the present invention, it is possible to efficiently perform seamless migration of a distributed ledger and the like between BC platforms.

### BRIEF DESCRIPTION OF DRAWINGS

FIG. 1 is a diagram illustrating an example of a computer system constituting a migration support system according to an embodiment;

FIG. 2 is a diagram illustrating a hardware configuration example of a distributed ledger node according to the embodiment;

FIG. 3 illustrates a configuration example of a blockchain included in a distributed ledger of the distributed ledger node according to the embodiment;

FIG. 4A illustrates a configuration example of state information in the distributed ledger in the embodiment;

FIG. 4B illustrates a configuration example of state information in the distributed ledger in the embodiment;

FIG. 5 illustrates a flow example of a migration support method according to the embodiment;

FIG. 6 illustrates a flow example of the migration support method according to the embodiment;

FIG. 7 illustrates a configuration example of the blockchain included in the distributed ledger of the distributed ledger node according to the embodiment;

FIG. 8 illustrates a flow example of the migration support method according to the embodiment;

FIG. 9 illustrates a configuration example of the blockchain included in the distributed ledger of the distributed ledger node according to the embodiment;

FIG. 10 illustrates a flow example of the migration support method according to the embodiment;

FIG. 11 illustrates a configuration example of the blockchain included in the distributed ledger of the distributed ledger node according to the embodiment;

FIG. 12 illustrates a flow example of the migration support method according to the embodiment; and

FIG. 13 is a conceptual diagram illustrating a configuration example of distributed ledger nodes in migration source and destination blockchain platforms in the embodiment.

### DESCRIPTION OF EMBODIMENTS

<<System Configuration>>

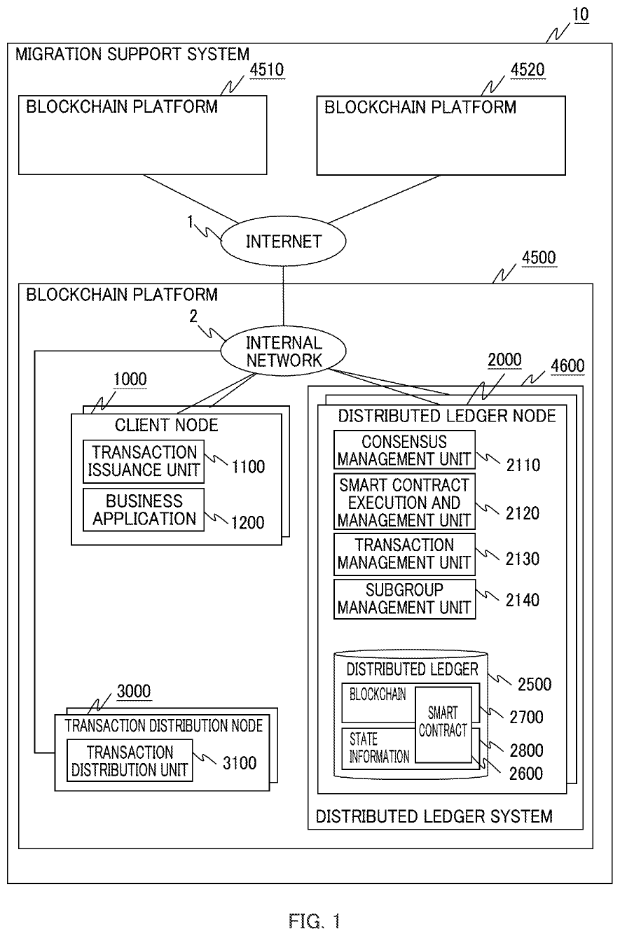

Embodiments of the present disclosure will be described below in detail with reference to the drawings. FIG. 1 is a diagram illustrating an example of a computer system constituting a migration support system 10 according to an embodiment. The migration support system 10 illustrated in FIG. 1 is a computer system that can efficiently perform seamless migration of a distributed ledger and the like between BC platforms.

The migration support system 10 according to the present embodiment includes a plurality of blockchain platforms 4500 to 4520. More specifically, the migration support system 10 includes a migration source blockchain platform and a migration destination blockchain platform which are involved in the migration of a distributed ledger system. Note that in the following description, among the blockchain platforms 4500 to 4520, the blockchain platform 4500 will be used as a representative example.

Such a blockchain platform 4500 is configured to include one or more client nodes 1000, one or more distributed ledger nodes 2000, and one or more transaction distribution nodes 3000.

These devices are connected to an internal network 2 through a physical or logical communication line. The blockchain platform 4500 is connected to the other blockchain platforms, that is, the blockchain platforms 4510 and 4520 via the Internet 1.

In the present embodiment, there are a plurality of distributed ledger nodes 2000 in the blockchain platform 4500. In the blockchain platform 4500, it is assumed that each distributed ledger node 2000 is managed by a plurality of organizations (e.g., a plurality of business operators, a plurality of organizations, and/or a plurality of vendors) that constitute a consortium.

In other words, the above-described blockchain platform 4500 is an infrastructure for operating a consortium distributed ledger system 4600 in which only computers authorized by a plurality of specific parties/people or one specific party/person are participants in transactions.

Similarly, there are a plurality of client nodes 1000 in the blockchain platform 4500. The client nodes 1000 are operated and used separately by the above-described plurality of organizations.

There may be a plurality of transaction distribution nodes 3000 in the blockchain platform 4500. The plurality of transaction distribution nodes 3000 may coexist while sharing same information so as to ensure redundancy in case of failure occurring in the distributed ledger node(s) 2000.

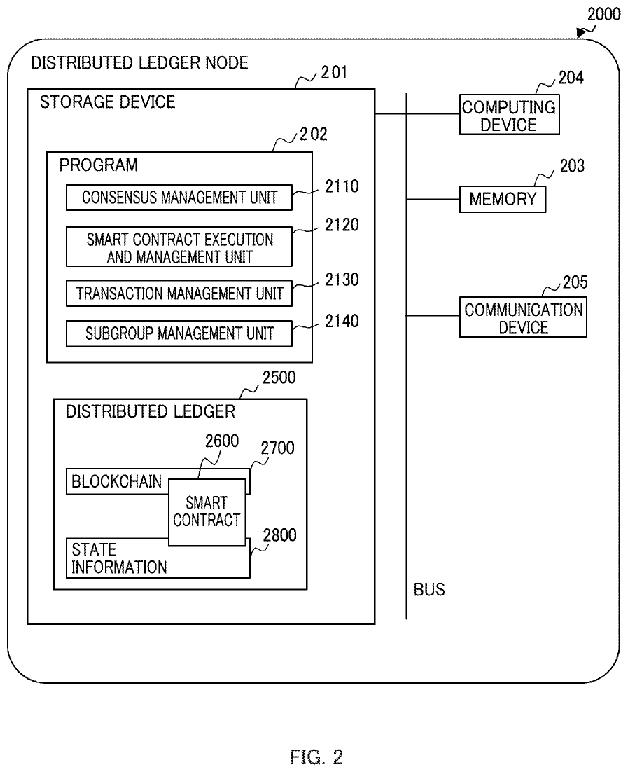

Note that the physical entity of each of the client node 1000, the distributed ledger node 2000, and the transaction distribution node 3000 is a general computer including a processor, a memory, and a data bus. The hardware configuration of such a computer will be described below with reference to FIG. 2.

<<Configuration of Each Device>>

The above-described client node 1000 includes a transaction issuance unit 1100 and a business application 1200.

Of these, the business application 1200 is an application that receives input of business-related information from a user. The business application 1200 issues a TX via the transaction issuance unit 1100, and transmits the above-described user input content to the distributed ledger node(s) 2000.

Note that issuer information is added to the TX. The issuer information may include an organization ID and a node ID which are given in advance in association with an operating organization of the client node 1000, and authentication information (secret key) issued for each client node.

The distributed ledger node 2000 includes a consensus management unit 2110, a smart contract execution and management unit 2120 (hereinafter, also referred to as an SC execution and management unit), a transaction management unit 2130, a subgroup management unit 2140, and a distributed ledger 2500.

Note that the distributed ledger 2500 is defined for each subgroup in the consortium. The same distributed ledger is shared among the nodes belonging to one subgroup.

The distributed ledger node 2000 uses a function of the transaction management unit 2130 to receive a TX. The distributed ledger node 2000 also uses a function of the consensus management unit 2110 to build a consensus with other distributed ledger nodes that the TX is accepted.

Once the consensus is built, the distributed ledger node 2000 deploys an SC and executes the deployed SC through a function of the SC execution and management unit 2120. By executing this SC, the distributed ledger node 2000 records a TX history and the result of execution in the distributed ledger 2500.

The transaction management unit 2130 of the distributed ledger node 2000 provides a function and interface for receiving a TX and a function and interface for acquiring and browsing history information of the TX, in response to a request from each node such as the client node 1000.

In the distributed ledger system 4600 of the present embodiment, the members participating in the consortium, that is, the organizations and the distributed ledger nodes 2000 are managed by the distributed ledgers 2500 of the respective organizations.

The subgroup management unit 2140 of the distributed ledger node 2000 provides new registration of an organization and a subgroup and additional functions.

In the distributed ledger system 4600 of the present embodiment, it is assumed that a pair of a secret key and a public key is used to authenticate a participating organization, sign a TX, control SC execution authority, and the like.

Information on the secret key of each distributed ledger node 2000 is stored and managed in the transaction management unit 2130 of the corresponding distributed ledger node 2000. On the other hand, information on the public key is shared among all the distributed ledger nodes 2000.

At any time in response to receiving a TX, the transaction management unit 2130 of the distributed ledger node 2000 checks whether or not the issuer of the TX is an authorized and correct participant. Note that a known or well-known technique may be applied to a method for generating the above-described pair of the public key and the secret key and a method for verifying the signature, and thus details of the technique are not described herein.

The distributed ledger 2500 stores and manages a smart contract 2600 related to business and a TX result with the SC. As a data structure of the TX result, it is assumed that the history of the TX is a blockchain 2700 and state information 2800 based on the execution result of the TX is held in a table format.

On the other hand, the transaction distribution node 3000 includes a transaction distribution unit 3100. The transaction distribution unit 3100 provides a function of ordering the transactions received by each distributed ledger node 2000 within the above-described subgroup and broadcasting them to all the distributed ledger nodes 2000.

<<Hardware Configuration>>

The hardware configuration of the distributed ledger node 2000 is illustrated in FIG. 2. The distributed ledger node 2000 includes a storage device 201, a memory 203, a computing device 204, and a communication device 205.

Of these devices, the storage device 201 includes a suitable nonvolatile storage element such as an SSD (Solid State Drive) or a hard disk drive.

The memory 203 includes a volatile storage element such as a RAM.

The computing device 204 is a CPU that loads programs 202 stored in the storage device 201 into the memory 203 to execute them so that the distributed ledger node 2000 is integrally controlled and various determinations, computation, and control processing are performed.

The communication device 205 is a network interface card that is responsible for communication processing with the distributed ledger nodes of the other blockchain platforms 4510 and 4520 via the Internet 1 and communication processing with other devices via the internal network 2. The other devices include the client nodes 1000, the other distributed ledger nodes 2000, and the transaction distribution nodes 3000.

Note that the distributed ledger node 2000 may include an input device and an output device. The input device is a suitable device such as a keyboard, a mouse, or a microphone for receiving a key input or a voice input from the user. The output device is a suitable device such as a display or a speaker for displaying processed data in the computing device 204.

In the storage device 201, at least the above-described distributed ledger 2500 is stored in addition to the programs 202 for implementing the functions required as the distributed ledger node 2000 of the present embodiment. Note that the functions implemented by the programs 202 include the consensus management unit 2110, the SC execution and management unit 2120, the transaction management unit 2130, and the subgroup management unit 2140.

<<Configuration Example of Distributed Ledger>>

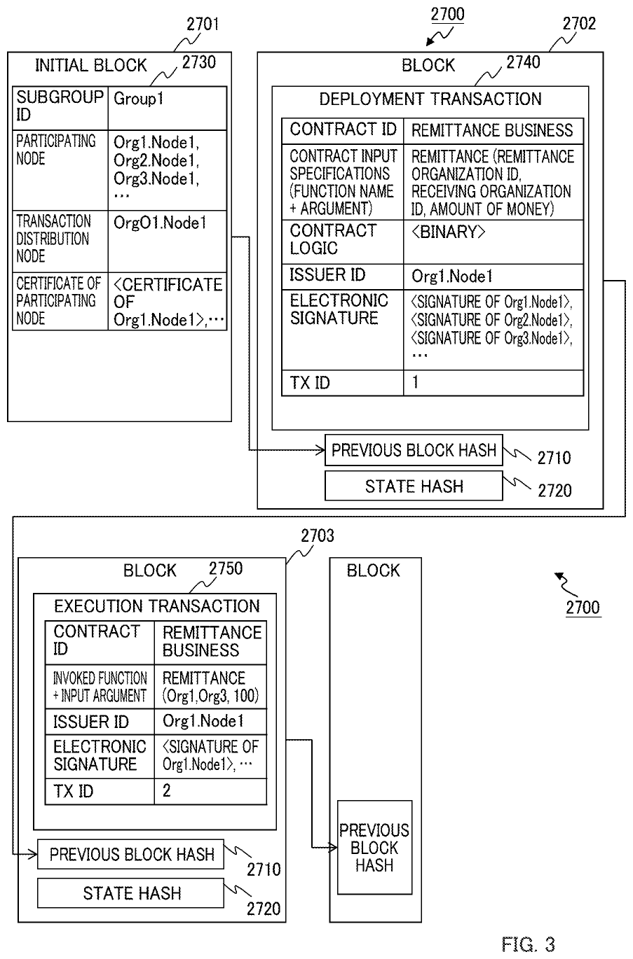

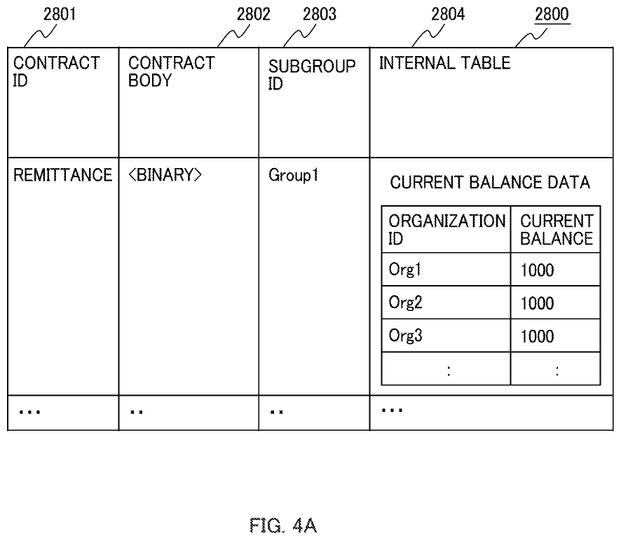

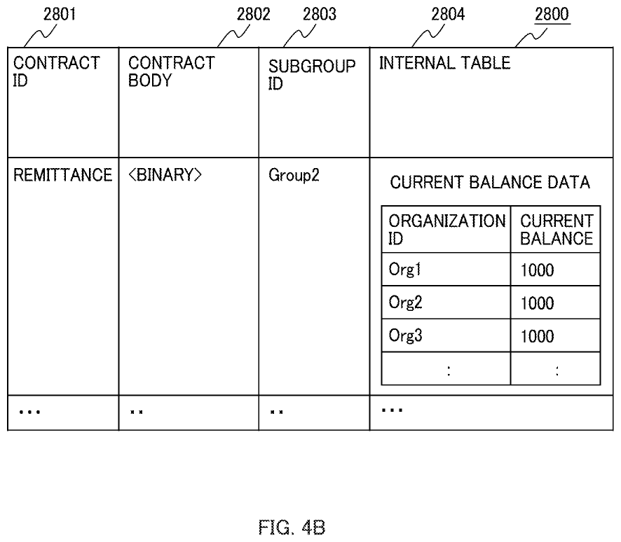

FIGS. 3 and 4 illustrate examples of a data structure stored in the distributed ledger 2500 included in the distributed ledger node 2000. Of these, FIG. 3 illustrates an example of the blockchain 2700 managed by the distributed ledger 2500.

In distributed ledger management using a blockchain, a plurality of TXs are grouped into blocks, each block has the hash of the previous block, and data is managed in a daisy chain. A change in the value of a block in the previous stage changes the hashes of all subsequent blocks even if the change is of one bit, which makes it difficult for the data to be tampered with.

Note that, in the present embodiment, for simplicity of description, one block is set for one TX, but the present invention is also applicable to a case where a plurality of TXs are collectively stored in one block.

Such a blockchain 2700 is composed of a series of blocks 2701 to 2703 as illustrated in the example of FIG. 3. Each of the blocks 2701 to 2703 includes TX information on either deployment or execution of an SC.

Each block also includes a hash 2710 of the previous block and a hash 2720 generated from state information described below.

With the above data structure, the history information of generation of a subgroup, and deployment and execution of the SC is managed as a chain of data in the BC 2700.

The initial block 2701 in the blockchain 2700 is an example of a block that stores the initial information of a subgroup. In an initial block 2730 of the present embodiment, an ID of the subgroup associated with the distributed ledger 2500 is defined.

The initial block 2730 includes IDs of nodes belonging to the subgroup and a list of certificates of the respective nodes. The initial block 2730 also includes an ID of the transaction distribution node 3000 that distributes the transaction.

The block 2702 is an example of a block storing a deployment TX 2740 of the SC. The deployment TX 2740 of the present embodiment includes a contract ID for uniquely identifying the contract and the logic of the contract (e.g., an executable binary).

The block 2702 also includes contract input specifications for the user to know function names of the contract and their arguments.

In the deployment TX 2740 of this example, “remittance” is defined as the function name of the SC having an ID of “remittance business”, and the logic of the function is also defined. In addition, the deployment TX 2740 includes an ID of the issuer of the deployment TX 2740 and electronic signatures used to verify that the data has not been tampered with. The deployment TX 2740 also includes an ID which is a unique identifier of the TX.

The block 2703 is an example of a block storing an execution TX 2750 of the SC. The execution TX 2750 of the present embodiment includes a contract ID of a contract to be invoked, a function name of the contract to be invoked, and information on input arguments.

In this example of the execution TX 2750, the SC function “remittance” having an ID of “remittance business” is to be invoked.

This SC has three arguments: a remittance organization ID, a receiving organization ID, and an amount of money, and their values are “Org1”, “Org3”, and “100”, respectively.

In addition, the execution TX 2750 includes an ID of the issuer of the execution TX 2750 and electronic signatures used to verify that the data has not been tampered with. Note that the execution TX 2750 may manage and hold information on nodes involved in consensus building as well as the issuer. The execution TX 2750 also includes an ID which is a unique identifier of the TX in the distributed ledger 2500.

Subsequently, FIGS. 4A and 4B illustrate examples of state information 2800 managed by the distributed ledger 2500. In distributed ledger management using a blockchain, usually, in order to acquire the latest state (e.g., account balance in the case of virtual currency), it is necessary to trace the blockchain.

However, even if such an operation is adopted, the processing efficiency is low. Thus, there is a method of caching the latest state information separately from the blockchain (e.g., “Hyperledger Fabric” referred to above). Therefore, also in the present embodiment, it is assumed that the latest state information is held. In the present embodiment, a state data area is prepared for each of the functions that the contract has.

The state information 2800 holds an ID 2801 which is the identifier of the contract, a body 2802 of the contract, and an identifier 2803 of the subgroup associated with the contract. Thus, the SC execution and management unit 2120 can acquire and execute the contract body using the contract ID and the function name as keys.

The state information 2800 also includes an internal table 2804 for holding an execution result of the SC. This internal table 2804 is updated every time the TX is executed. The internal table 2804 of the state information 2800 illustrated in FIGS. 4A and 4B is composed of a table referred to as “current balance data”, and is overwritten at any time with the information specified by the argument of the TX.

<<Flow of Migration Support Method>>

An actual procedure of a migration support method according to the present embodiment will be described below with reference to the drawings. Various operations corresponding to the migration support method described below are implemented by a program that is read into a memory or the like by the distributed ledger node 2000 operating on the blockchain platform included in the migration support system 10 and is executed. The program is composed of codes for performing various operations described below.

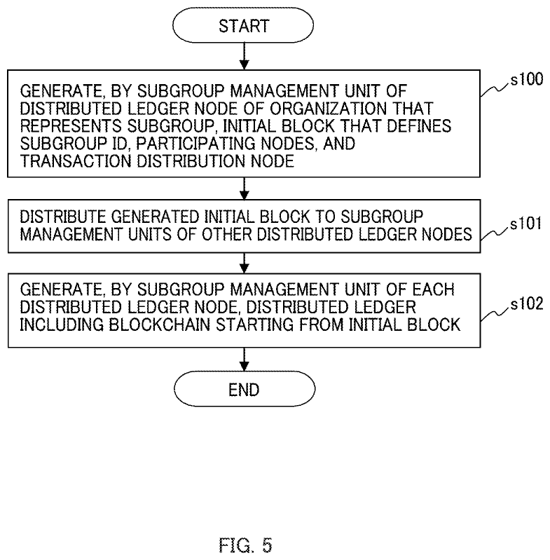

FIG. 5 is a flowchart illustrating an example of a process of newly generating a subgroup by the subgroup management unit 2140 of the distributed ledger node 2000. A specific example of the process will be described below.

When a plurality of organizations that are users of the blockchain platform 4500 attempt to generate a new subgroup, an administrator of the distributed ledger node 2000 of an organization that represents the subgroup has built a consensus with other organizations in advance, then will determine a subgroup ID, participating nodes, and a transaction distribution node 3000, and operate the client node 1000 to input them to the subgroup management unit 2140 of the distributed ledger node 2000.

Accordingly, the subgroup management unit 2140 of the distributed ledger node 2000 generates the initial block 2730 based on the information input from the client node 1000 (step s100).

Next, the subgroup management unit 2140 distributes the initial block 2730 generated in step s100 to the subgroup management units 2140 of the distributed ledger nodes 2000 of the other organizations (step s101).

On the other hand, the subgroup management unit 2140 of the distributed ledger node 2000 of each organization generates the distributed ledger 2500 including the blockchain 2700 starting from the above-described initial block 2730 (step s102).

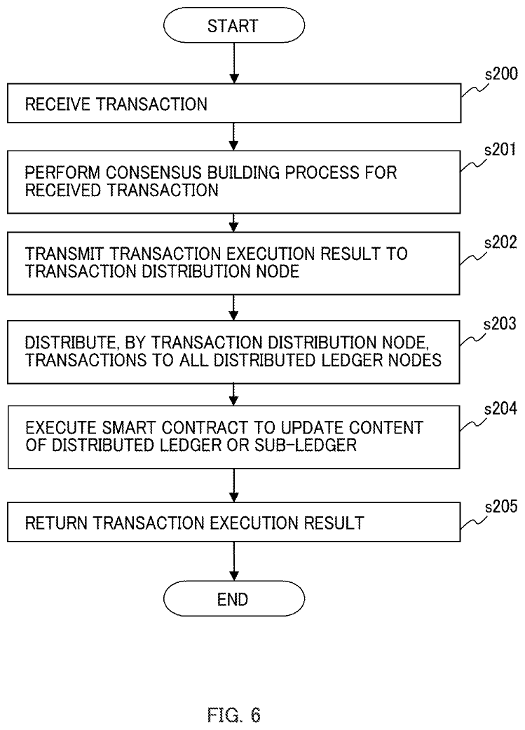

FIG. 6 illustrates an example of a process of executing a TX in the distributed ledger node 2000, that is, deployment and execution of an SC.

In this case, the transaction management unit 2130 of the distributed ledger node 2000 receives a TX from the TX issuer such as the client node 1000 (step s200).

The transaction management unit 2130 also assigns an ID to the TX received in step s200 and then passes it to the consensus management unit 2110.

Subsequently, the consensus management unit 2110 performs a consensus building process with the other distributed ledger nodes 2000 as to whether the received TX is to be executed or to be added to the blockchain 2700 as a block (step s201).

After the above-described consensus building is completed, the transaction management unit 2130 transmits the TX to the transaction distribution node 3000 via the SC execution and management unit 2120 (step s202).

On the other hand, the transaction distribution node 3000 orders the TXs transmitted from the distributed ledger nodes 2000 and distributes the TXs to all the distributed ledger nodes 2000 constituting the same distributed ledger system 4600 (step s203).

The distributed ledger node 2000 receives the TXs from the transaction distribution node 3000 and registers the TXs in the distributed ledger 2500 (step s204).

At that time, when the content of the TX is related to the deployment of the SC, the distributed ledger node 2000 registers the contract ID and the contract body as the state information 2800 of the distributed ledger 2500. The distributed ledger node 2000 adds a block including this TX to the end of the blockchain 2700.

On the other hand, when the content of the TX is related to the execution of the function defined in the SC, the distributed ledger node 2000 passes the function to be invoked and the input arguments specified in the TX to the SC having the contract ID specified in the TX and executes the SC.

The distributed ledger node 2000 updates the content of the distributed ledger 2500 based on the execution result. Specifically, the distributed ledger node 2000 updates the state information 2800 related to this contract based on the above-described execution result, and adds the execution TX as the last block of the blockchain 2700. At this time, the block addition is similarly executed for the other distributed ledger nodes sharing the same distributed ledger 2500.

When the content of a TX is related to the setting change of the SC, the distributed ledger node 2000 updates the setting information related to this contract defined in the state information 2800, and adds the execution TX as the last block of the blockchain 2700.

Finally, the transaction management unit 2130 of the distributed ledger node 2000 returns the execution result of the deployment TX to the TX issuer (step s205), and then the process ends.

Note that in the present embodiment, the transaction distribution node 3000 performs the broadcast processing in step s202, but the distributed ledger node 2000 may perform the broadcast processing.

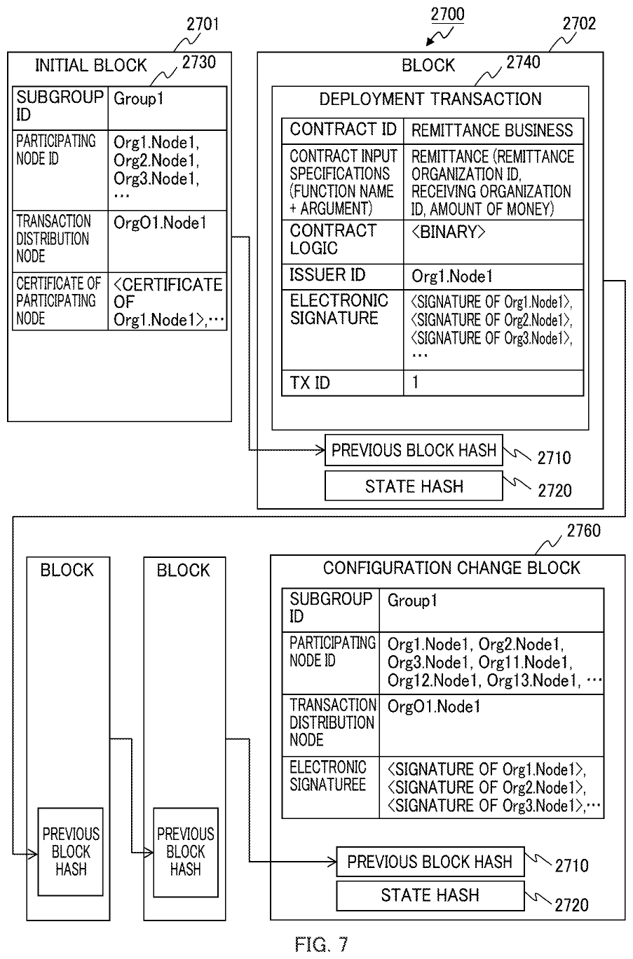

FIG. 7 illustrates an example of the blockchain 2700 managed by the distributed ledger 2500. In the blockchain 2700, a block 2704 is an example of a block storing configuration change information of the subgroup.

In a configuration change block 2760 of the present embodiment, a list of IDs of the nodes belonging to the subgroup is defined. The configuration change block 2760 also includes digital signatures of the participating nodes used to verify that the data has not been tampered with.

The electronic signature is generated by using the secret key of the distributed ledger node 2000, and can be verified by the public key that is paired with the secret key. The configuration change block 2760 also includes an ID of the transaction distribution node 3000 that distributes the transaction. Note that the configuration illustrated in FIG. 7 is the same as FIG. 3 except for the configuration change block 2760.

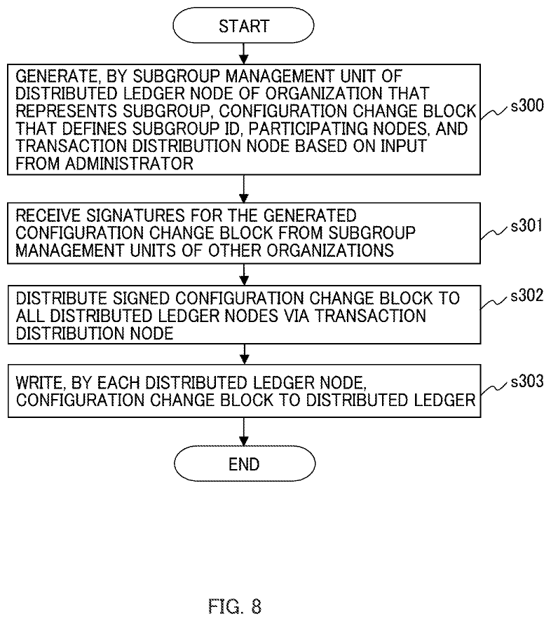

Subsequently, FIG. 8 illustrates an example of a process of changing a subgroup configuration performed by the subgroup management unit 2140 of the distributed ledger node 2000 in the present embodiment. A specific example of the process will be described below.

Here, when adding an organization to participate in the subgroup, the administrator of the distributed ledger node 2000 of the organization that represents the subgroup operates the client node 1000 to input the ID of a node to be added to the subgroup into the subgroup management unit 2140.

Accordingly, when the subgroup management unit 2140 receives the input from the above-described client node 1000, the subgroup management unit 2140 generates the configuration change block 2704 that defines the received information (step s300).

Next, the subgroup management unit 2140 receives signatures for the configuration change block 2704 from the subgroup management units 2140 of the distributed ledger nodes 2000 of the other organizations participating in the subgroup (step s301).

Subsequently, the subgroup management unit 2140 distributes the above-described signed configuration change block 2704 to the other distributed ledger nodes 2000 in the same subgroup (step s302).

The subgroup management unit 2140 of the distributed ledger node 2000 of each organization writes the above-described configuration change block 2704 to the blockchain 2700 (step s303), and then the process ends.

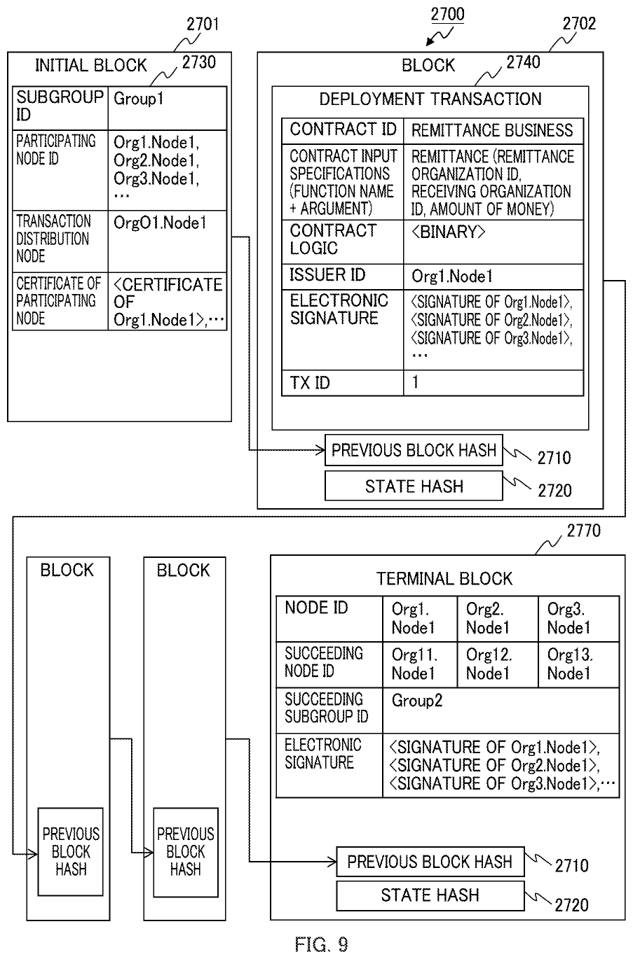

FIG. 9 illustrates an example of the blockchain 2700 managed by the distributed ledger 2500. In the blockchain 2700, a terminal block 2770 is an example of a block storing terminal information of the subgroup. An ID of a succeeding subgroup is defined in the terminal block 2770 of the present embodiment.

Further, in the terminal block 2770, a list of IDs of the nodes belonging to the corresponding subgroup and a list of IDs of succeeding nodes are defined.

The terminal block 2770 also includes digital signatures of the participating nodes used to verify that the data has not been tampered with. Further, the terminal block 2770 includes an ID of the transaction distribution node 3000 that distributes the transaction. Note that the configuration illustrated in FIG. 9 is the same as FIG. 3 except for the terminal block 2770.

The terminal block 2770 is information indicating the correspondence between the node ID of each of the organizations belonging to the subgroup on the migration source blockchain platform and the node ID assigned by the organization in the subgroup on the migration destination blockchain, that is, the succeeding node ID.

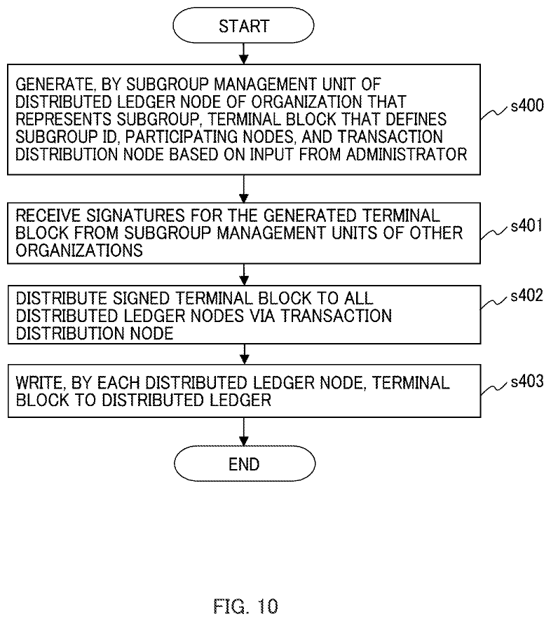

FIG. 10 illustrates an example of a process of terminating a subgroup configuration performed by the subgroup management unit 2140 of the distributed ledger node 2000 in the present embodiment. A specific example of the process will be described below.

Here, when terminating a subgroup, the administrator of the distributed ledger node 2000 of the organization that represents the subgroup operates the client node 1000 to input information on: the succeeding subgroup ID, the participating nodes, the succeeding nodes, and the succeeding transaction distribution node 3000, into the subgroup management unit 2140.

On the other hand, when the subgroup management unit 2140 receives the input from the above-described client node 1000, the subgroup management unit 2140 generates the terminal block 2770 that defines the received information (step s400).

Next, the subgroup management unit 2140 receives signatures for the above-described terminal block 2770 from the subgroup management units 2140 of the distributed ledger nodes 2000 of the other organizations participating in the subgroup (step s401).

Further, the subgroup management unit 2140 distributes the terminal block 2770 signed as described above to the other distributed ledger nodes 2000 in the same subgroup (step s402).

The subgroup management unit 2140 of the distributed ledger node 2000 of each organization writes the above-described terminal block 2770 to the terminal of the blockchain 2700 (step s403), and then the process ends. The existence of this terminal block 2770 in the blockchain 2700 means that the distributed ledger 2500 will not be updated thereafter.

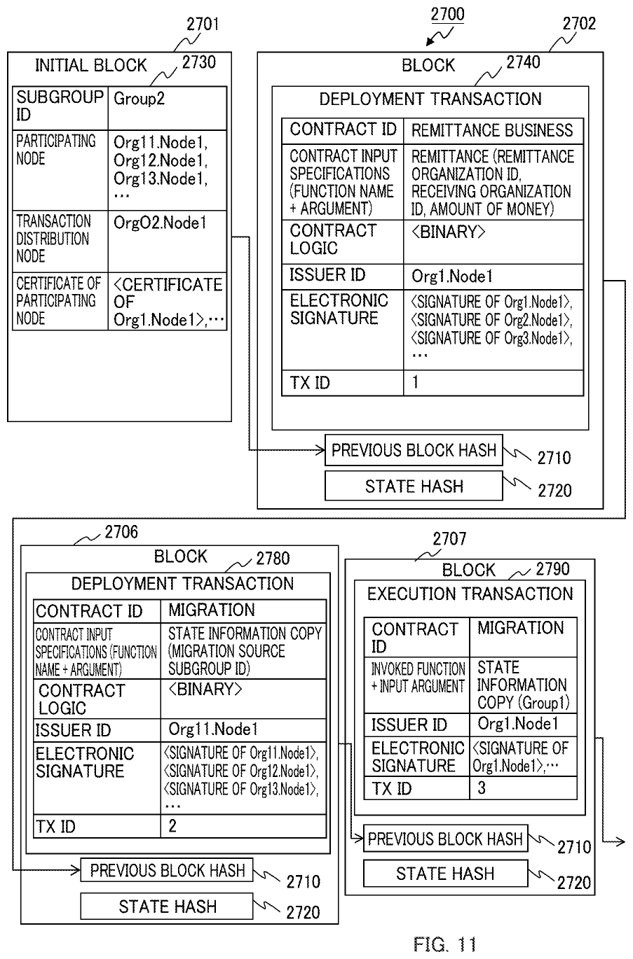

FIG. 11 illustrates an example of the blockchain 2700 managed by the distributed ledger 2500 of the present embodiment. In the blockchain 2700, a block 2706 is an example of a block storing a deployment TX 2780 of the SC.

In this example of the deployment TX 2780, “state information copy” is defined as the function name of the SC having an ID of “migration”, and the logic of the function is also defined. In addition, the deployment TX 2780 includes an ID of the issuer of the deployment TX 2780 and electronic signatures used to verify that the data has not been tampered with. The deployment TX 2780 also includes an ID which is a unique identifier of the TX.

A block 2707 is an example of a block storing an execution TX 2790 of the SC. The execution TX 2790 of the present embodiment includes a contract ID of a contract to be invoked, a function name of the contract to be invoked, and information on input arguments.

In this example of the execution TX 2790, the SC function “state information copy” having an ID of “migration” is to be invoked. The argument for this function is a migration source subgroup ID, and its value is “Group1”.

In addition, the execution TX 2790 includes an ID of the issuer of the execution TX 2790 and electronic signatures used to verify that the data has not been tampered with. Note that the execution TX 2790 may manage and hold information on nodes involved in consensus building as well as the issuer. The execution TX 2790 includes an ID which is a unique identifier of the TX.

Note that the configuration illustrated in FIG. 11 is the same as FIG. 3 except for the blocks 2706 and 2707.

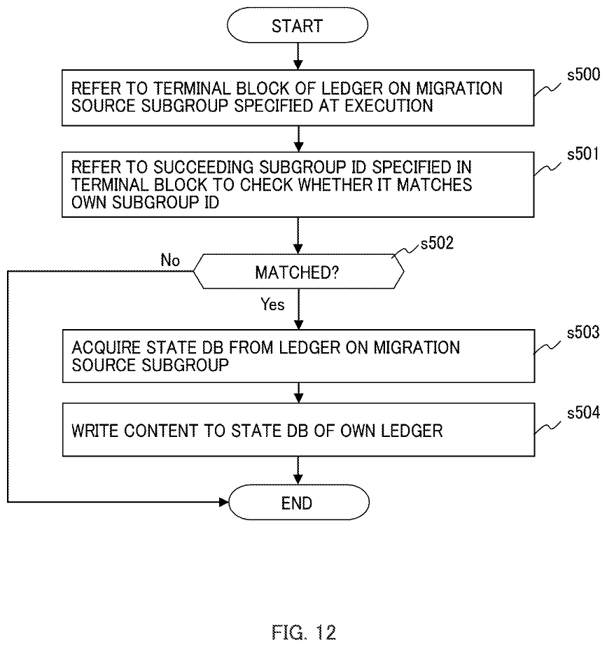

FIG. 12 illustrates an example of a process performed by the smart contract execution and management unit 2120 of the distributed ledger node 2000 in the present embodiment based on the migration SC shared among the distributed ledger nodes 2000 belonging to “Group2”. A specific example of the process will be described below.

First, the smart contract execution and management unit 2120 of the distributed ledger node 2000 refers to the distributed ledger on its own node to search for a blockchain in which the subgroup ID defined in the initial block matches the migration source subgroup ID specified at the time of SC execution (step s500).

Next, the smart contract execution and management unit 2120 refers to the terminal block of the blockchain to acquire the ID of the succeeding subgroup and to check whether or not the acquired ID matches the ID of its own subgroup (step s501).

If they do not match as a result of the checking described above (step s502: No), the process in the smart contract execution and management unit 2120 ends.

On the other hand, if they match as a result of the checking described above (step s502: Yes), the smart contract execution and management unit 2120 acquires the content of the state information 2800 from the distributed ledger 2500 (step s503).

Finally, the smart contract execution and management unit 2120 writes the content acquired in step s503 to the state information 2800 of the distributed ledger 2500 in its own subgroup (step s504), and then the process ends.

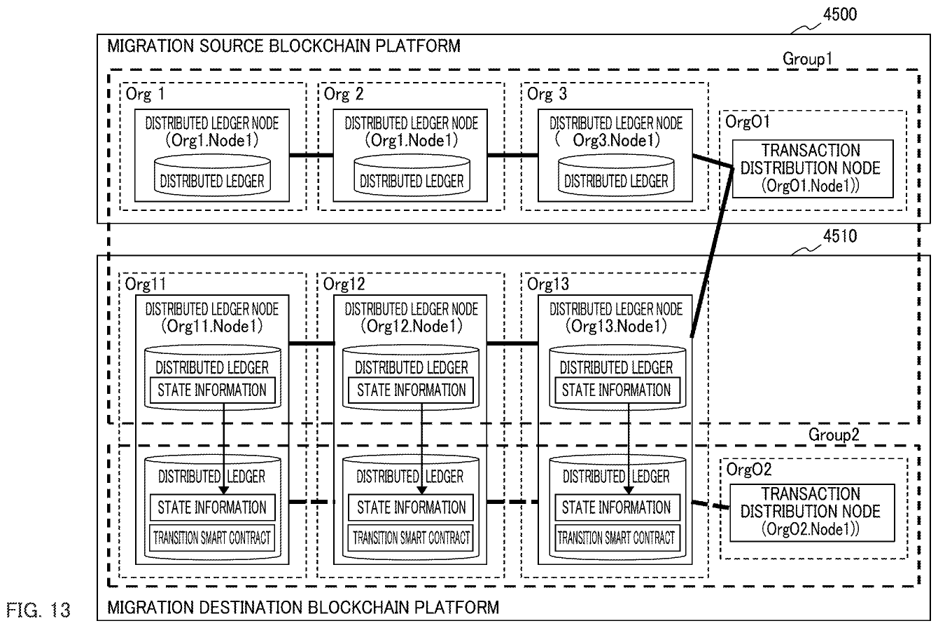

FIG. 13 is a conceptual diagram illustrating a configuration example of distributed ledger nodes in migration source and destination blockchain platforms 4500 and 4510 in the present embodiment. In such a configuration, business operators participating in a consortium are exemplified as organizations “Org1” to “Org3” and organizations “Org11” to “Org13”.

The consortium built on the migration source blockchain platform 4500 is composed of organizations “Org1” to “Org3”. Each of these organizations operates one distributed ledger node 2000. For example, organization “Org1” operates distributed ledger node “Node1”.

On the other hand, there are organizations “Org11” to “Org13” in the consortium built on the migration destination blockchain platform 4510. Note that the entities of organizations “Org11” to “Org13” correspond to the above-described organizations “Org1” to “Org3” in the migration source blockchain platform 4500, respectively.

Specifically, organization “Org1” of the migration source blockchain platform 4500 corresponds to organization “Org11” in the migration destination blockchain platform 4510. Similarly, organization “Org2” of the migration source blockchain platform 4500 corresponds to organization “Org12” in the migration destination blockchain platform 4510, and organization “Org3” of the migration source blockchain platform 4500 corresponds to organization “Org13” in the migration destination blockchain platform 4510.

Within such a consortium, there is a subgroup of “Group1”. Distributed ledger node “Node1” of organization “Org1”, distributed ledger node “Node1” of organization “Org2”, and distributed ledger node “Node1” of organization “Org3” belong to subgroup “Group1”.

Hereinafter, a process will be described in which the migration source blockchain platform 4500 is stopped, the data of the distributed ledger 2500 is taken over, and then the business on the migration destination blockchain platform 4510 is resumed.

Herein, before the start of the migration procedure, distributed ledger nodes “Org1.Node1” to “Org3.Node1” of organizations “Org1” to “Org3” belong to subgroup “Group1”, and the blockchain 2700 and the state information 2800 of the distributed ledger 2500 are in the states illustrated in FIGS. 3 and 4A, respectively.

First, an administrator of organization “Org1” that represents the subgroup operates the client node 1000 to instruct the subgroup management unit 2140 of “Org1.Node1” to add distributed ledger nodes “Org11.Node1” to “Org13.Node1” of organizations “Org11” to “Org13” to subgroup “Group1”.

On the other hand, when the subgroup management unit 2140 receives the above-described instruction for addition from the client node 1000, the subgroup management unit 2140 generates the configuration change block 2760 that defines the information on the instruction.

Next, the subgroup management unit 2140 receives signatures for the above-described configuration change block 2760 from the subgroup management units 2140 of the distributed ledger nodes 2000 of the other organizations participating in the subgroup, that is, “Org2” to “Org3” and “Org11” to “Org13”.

Subsequently, the subgroup management unit 2140 distributes the above-described signed configuration change block 2760 to the other distributed ledger nodes 2000 via transaction distribution node “OrgO1.Node1”.

On the one hand, the subgroup management unit 2140 in the distributed ledger node 2000 of each organization writes the configuration change block 2760 to the terminal of the blockchain 2700. In that case, the blockchain 2700 is in the state illustrated by way of example in FIG. 7.

On the other hand, the administrator of “Org1” operates the client node 1000 to instruct the subgroup management unit 2140 of “Org11.Node1” to newly generate a subgroup of “Group2” to be the migration destination. At this time, distributed ledger nodes “Org11.Node1” to “Org13.Node1” of organizations “Org11” to “Org13” are specified as the participating nodes, and “Org2.Node1” is specified as the transaction distribution node 3000.

In response to this, the subgroup management unit 2140 of distributed ledger node “Org11.Node1” generates the initial block 2730 and distributes the generated initial block 2730 to the subgroup management unit 2140 of each of the distributed ledger nodes 2000 of organizations “Org12” and “Org13”.

The subgroup management unit 2140 in the distributed ledger node 2000 of each organization generates the distributed ledger 2500 including the blockchain 2700 starting from the above-described initial block 2730.

Next, the administrator of organization “Org1” operates the client node 1000 to instruct the subgroup management unit 2140 of distributed ledger node “Org1.Node1” to end the distributed ledger 2500 of subgroup “Group1”. At that time, “Group1” as the succeeding subgroup ID, “Org1.Node1” to “Org3.Node1” as the participating nodes, “Org11.Node1” to “Org13.Node1” as the succeeding nodes, and “OrgO2.Node1” as the succeeding transaction distribution node 3000, are specified.

On the other hand, when receiving the above-described specified information, the subgroup management unit 2140 of distributed ledger node “Org1.Node1” generates the terminal block 2770 that defines that information.

Next, the subgroup management unit 2140 of distributed ledger node “Org1.Node1” receives signatures for the above-described terminal block 2770 from the subgroup management units 2140 of the distributed ledger nodes 2000 of organizations “Org2” and “Org3” participating in the subgroup.

Next, the subgroup management unit 2140 of distributed ledger node “Org1.Node1” distributes the signed terminal block 2770 to the other distributed ledger nodes 2000 via transaction distribution node “OrgO1.Node1”.

When receiving the distributed terminal block 2770, the subgroup management units 2140 of distributed ledger nodes “Org11.Node1” to “Org13.Node1” each write the terminal block 2770 to the terminal of the blockchain 2700 so as not to update the migration distributed ledger.

Subsequently, an administrator of organization “Org11” operates the client node 1000 to deploy the migration SC and the business SC on the distributed ledger node 2000. The smart contract execution and management unit 2120 included in the distributed ledger node 2000 executes the migration SC shared among the distributed ledger nodes in subgroup “Group2”.

The smart contract execution and management units 2120 of distributed ledger nodes “Org11.Node1” to “Org13.Node1” belonging to subgroup “Group2” each refer to the distributed ledger 2500 on its own distributed ledger node to search for the blockchain 2700 in which the subgroup ID defined in the initial block 2730 matches a migration source subgroup ID of “Group1” specified at the time of SC execution.

Next, the smart contract execution and management unit 2120 refers to the terminal block 2770 of the blockchain 2700 to acquire the ID of the succeeding subgroup and to check whether or not the acquired ID matches ID “Group2” of its own subgroup. If they match as a result of the checking, the smart contract execution and management unit 2120 acquires the content of the state information 2800 from the distributed ledger 2500.

Finally, the smart contract execution and management unit 2120 writes the content acquired above to the state information 2800 of the distributed ledger 2500 in its own subgroup. As a result of the above, the blockchain 2700 and the state information 2800 of the distributed ledger 2500 are in the states illustrated in FIGS. 11 and 4B, respectively.

As illustrated above, by using the present invention, the past TX history is taken over by the migration destination BC platform even if a ledger on the migration source BC platform is finally deleted in order to migrate the BC platform. In addition, it is possible to share the correspondence between a plurality of pieces of organization definition information associated with one organization among the participating organizations with consensus built in a form of not being tampered with.

Although the above description is specific for the best mode for carrying out the present invention, the present invention is not limited to this, and various modifications are possible without departing from the spirit and scope of the invention.

According to the present embodiment, in order to migrate a distributed ledger system between BC platforms, even if a distributed ledger on the migration source BC platform is finally deleted, the past TX history is taken over by the migration destination BC platform, so that operating costs will not be excessive. In addition, it is possible to share the correspondence between a plurality of pieces of organization definition information associated with one organization among the participating organizations with consensus built in a form of not being tampered with.

That is, it is possible to efficiently perform seamless migration of a distributed ledger and the like between BC platforms.

At least the following will be made clear by the description in the present specification. In the migration support system according to the present embodiment, any one node of the first distributed ledger system or the second distributed ledger system may further perform a process of copying a distributed ledger of the first distributed ledger system to another blockchain platform to build the second distributed ledger system, and linking a blockchain included in the distributed ledger of the first distributed ledger system and a blockchain included in a distributed ledger of the second distributed ledger system based on the correspondence recorded in the distributed ledger of the first distributed ledger system.

This makes it possible to establish the continuity of the distributed ledger between BC platforms and thus to verify that the distributed ledger has not been tampered with, for example, in audit work that may be required thereafter. As a result, it is possible to more efficiently perform seamless migration of a distributed ledger and the like between BC platforms.

In the migration support system according to the present embodiment, the any one node may further perform a process of copying a content of state information of the first distributed ledger system to state information of the second distributed ledger system based on the correspondence recorded in the distributed ledger of the first distributed ledger system.

This makes it possible to seamlessly migrate state information between BC platforms. As a result, it is possible to efficiently perform seamless migration of a distributed ledger and the like between BC platforms.

In the migration support system according to the present embodiment, the any one node may perform a process to be performed when migration is performed to build the second distributed ledger system by executing a smart contract that defines the process.

This makes it possible to efficiently perform the process involved in the above-described migration with the processing content for which consensus has been built among the participants in advance. As a result, it is possible to efficiently perform seamless migration of a distributed ledger and the like between BC platforms.

In the migration support system according to the present embodiment, the node may record correspondence between a first subgroup built on the first distributed ledger system and a second subgroup build on the second distributed ledger system into a sub-ledger shared within the first subgroup in the storage device, and record, based on the correspondence recorded in the sub-ledger, correspondence between an organization participating in the first subgroup and a second organization participating in a first subgroup built on the second distributed ledger system into the sub-ledger shared within the first subgroup.

This makes it possible to migrate the sub-ledger in consideration of a so-called BC platform channel. As a result, it is possible to efficiently perform seamless migration of a distributed ledger and the like between BC platforms.

In the migration support system according to the present embodiment, the any one node of the first distributed ledger system or the second distributed ledger system may copy a distributed ledger of the first distributed ledger system to the other blockchain platform to build the second distributed ledger system, and link a blockchain included in the sub-ledger shared within the first subgroup and a blockchain included in a sub-ledger shared within the second subgroup based on the correspondence recorded in the sub-ledger shared within the first subgroup.

This makes it possible to establish the continuity of the sub-ledger between BC platforms and thus to verify that the sub-ledger has not been tampered with, for example, in audit work that may be required thereafter. As a result, it is possible to efficiently perform seamless migration of a distributed ledger and the like between BC platforms.

In the migration support system according to the present embodiment, the any one node may copy a content of state information included in the sub-ledger shared within the first subgroup to state information included in a sub-ledger shared within the second subgroup based on the correspondence recorded in the sub-ledger shared within the first subgroup.

This makes it possible to seamlessly migrate state information in consideration of a BC platform channel. As a result, it is possible to efficiently perform seamless migration of a distributed ledger and the like between BC platforms.

In the migration support system according to the present embodiment, the any one node may perform a process to be performed when a distributed ledger system is migrated between the first and second subgroups to build the second distributed ledger system by executing a smart contract that defines the process.

This makes it possible to efficiently perform the process involved in the above-described migration with the processing content for which consensus has been built among the participants in advance. As a result, it is possible to efficiently perform seamless migration of a distributed ledger and the like between BC platforms.

What is claimed is:

1. A migration support system comprising
a node of a first distributed ledger system built on a blockchain platform, wherein the node includes:
a storage device that holds information on organizations that are allowed to participate in a distributed ledger system on each of blockchain platforms; and
a computing device configured to, when the first distributed ledger system is migrated to another blockchain platform to build a second distributed ledger system, record, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

2. The migration support system according to claim 1, wherein
any one node of the first distributed ledger system or the second distributed ledger system further performs a process of copying a distributed ledger of the first distributed ledger system to the other blockchain platform to build the second distributed ledger system, and linking a blockchain included in the distributed ledger of the first distributed ledger system and a blockchain included in a distributed ledger of the second distributed ledger system based on the correspondence recorded in the distributed ledger of the first distributed ledger system.

3. The migration support system according to claim 2, wherein
the any one node further performs a process of copying a content of state information of the first distributed ledger system to state information of the second distributed ledger system based on the correspondence recorded in the distributed ledger of the first distributed ledger system.

4. The migration support system according to claim 1, wherein
the any one node performs a process to be performed when migration is performed to build the second distributed ledger system by executing a smart contract that defines the process.

5. The migration support system according to claim 1, wherein
the node records correspondence between a first subgroup built on the first distributed ledger system and a second subgroup built on the second distributed ledger system into a sub-ledger shared within the first subgroup in the storage device, and records, based on the correspondence recorded in the sub-ledger, correspondence between an organization participating in the first subgroup and a second organization participating in a first subgroup built on the second distributed ledger system into the sub-ledger shared within the first subgroup.

6. The migration support system according to claim 5, wherein
any one node of the first distributed ledger system or the second distributed ledger system copies a distributed ledger of the first distributed ledger system to the other blockchain platform to build the second distributed ledger system, and links a blockchain included in the sub-ledger shared within the first subgroup and a blockchain included in a sub-ledger shared within the second subgroup based on the correspondence recorded in the sub-ledger shared within the first subgroup.

7. The migration support system according to claim 6, wherein
the any one node copies a content of state information included in the sub-ledger shared within the first subgroup to state information included in the sub-ledger shared within the second subgroup based on the correspondence recorded in the sub-ledger shared within the first subgroup.

8. The migration support system according to claim 5, wherein
the any one node performs a process to be performed when a distributed ledger system is migrated between the first and second subgroups to build the second distributed ledger system by executing a smart contract that defines the process.

9. A migration support method performed by a node of a first distributed ledger system built on a blockchain platform, the migration support method comprising:
holding information on organizations that are allowed to participate in a distributed ledger system on each of blockchain platforms in a storage device; and
recording, when the first distributed ledger system is migrated to another blockchain platform to build a second distributed ledger system, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.

10. A node of a first distributed ledger system built on a blockchain platform, comprising:
a storage device that holds information on organizations that are allowed to participate in a distributed ledger system on each of blockchain platforms; and
a computing device configured to, when the first distributed ledger system is migrated to another blockchain platform to build a second distributed ledger system, record, in a distributed ledger of the first distributed ledger system, correspondence between organizations participating in the first distributed ledger system and organizations participating in the second distributed ledger system, based on information on organizations that are allowed to participate in each distributed ledger system on the blockchain platform and the other blockchain platform, the information being held in the storage device.
